(19) United States
(12) Patent Application Publication
(10) Pub. No.: US 2006/0068836 A1
(43) Pub. Date: Mar. 30, 2006

(54) Structure of a mobile terminal for different communication systems

(75) Inventor: Patrick Nickel, Doersdorf (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/536,235

(22) PCT Filed: Nov. 20, 2003
(86) PCT No.: PCT/IB03/05284

§ 371 Date: May 24, 2005

(30) Foreign Application Priority Data
Nov. 28, 2002 (DE) 10255474.9

(51) Int. Cl. H04M 1/00

(52) U.S. Cl. 455/552.1

(57) ABSTRACT

A mobile terminal (1) is to be suitably constructed for different communication systems. The terminal contains in its physical layer exchangeable receive modules (3) which are coupled with higher layers via a convergence layer (4). In the higher shifts is arranged a reconfigurable protocol stack (9, 10) for the different protocols of the communication systems. These protocols are stored in a data base (14) remote from the terminal (1) and are loaded in the protocol stack (9, 10) by means of a standard system (11).

The invention relates to the structure, the architecture, of a mobile terminal for different communication systems which work with different air interfaces and different protocols.

Various communication systems are known and being developed. Such communication systems are particularly GSM (Global System for Mobile Communication), GPRS (General Packet Radio Service), FDGE (further development of GPRS), UMTS (Universal Mobile Telecommunication System), WLAN (Wireless Local Area Network), Bluetooth (standard for wireless data transmission over short distances), PAN (Personal Area Network), BAN (Body Area Network), DVB (Digital Video Broadcasting), DAB (Digital Audio Broadcasting). These systems work according to different standards with different air interfaces in different protocols. The terminals belonging to one of the communication systems are usually not suitable for operation in another system. They support only one system. Also mobile terminals are known which support a plurality of wireless communication systems such as GSM, GPRS, Bluetooth. These appliances are expensive because they need to have in their architecture separately for each of the systems in addition to its own RF receive portion in the analog physical layer, all the software components and hardware components in higher layers. Such terminals cannot be converted to other communication systems than those provided.

In WO 00/51 376 A1 is described the processing of the RF signal in the physical layer of the terminal. Ways of processing in the layers above the physical layer are not mentioned.

WO 01/15 471 A1 describes the use of parts of the 3G-Core network in 2G-networks.

US 2001/0007821 A1 describes a terminal for use in a first public network and in a preferred local, second network. A variability is not provided.

It is an object of the invention to propose a structure of the type defined in the opening paragraph, so that the terminal can be flexibly adapted to various communication systems, without the need to provide all software components and hardware components from the start.

According to the invention the above object is achieved by the characteristic features of claim 1.

The terminal is equipped with receive modules for those communication systems in which it is to be functioning. Preferably, the receive modules in the terminal are arranged exchangeably, so that the user or service operator can adapt or upgrade the terminal to other or further communication systems. The convergence layer of the terminal connects the receive module with the next higher layer, for example, the usual baseband portion. The protocols belonging to the communication systems are software components and not permanently stored in the terminal. They are stored in the database and may be called from the database via a base station whenever required and stored in the protocol stack of the terminal for the respective use.

To initialize the terminal in the respective communication system, the standard system is provided by means of which the software components of the respective communication system are taken over in the reconfigurable protocol stack of the terminal. The described terminal is then variable in its use in different communication systems without the need to permanently contain all the protocols of all the communication systems. Only the receive modules adapted to the respective communication systems need a variable adaptation as regards hardware. The protocols necessary for the communication in the respective communication system can be called from the database as required via software.

Then it is highly advantageous that not a separate terminal is to be manufactured and used for each communication system or group of communication systems. This lowers the cost of the terminals. Such a terminal is suitable for existing and future communication systems when respective receive modules are built in. The protocols of the communication systems are stored in the central database and transmitted to the terminal for the time of use and the type of use as required.

The protocol stack is preferably subdivided into a general protocol stack permanently stored in the terminal and a specific protocol stack corresponding to the standard of the respective communication system, which specific protocol stack can be loaded from the data base into the terminal via the standard system. This achieves that only those protocol dates are to be transmitted from the database to the terminal that are different in the communication systems. Identical data of the communication systems need not be transmitted from the database to the terminal.

The terminal preferably comprises two specific protocol stacks for two communication systems. This shortens the time necessary for switching over the terminal when it leaves the area of a cell of one communication system and moves to the area of a cell of another communication system. This achieves that before the terminal is switched over, already the protocols of the next-suitable cell in the cellular network are stored in the protocol stack. This largely avoids interruptions of the communication when a change is made from the cell of one communication system to the area of the cell of another communication system.

The standard system is preferably down-link oriented. This achieves a highest possible data rate in the direction from the base station to the mobile terminal. The data rate is high enough to load the protocol data of the respective communication system in the protocol stack of the terminal in a brief period of time.

Further advantageous embodiments of the invention can be learnt from the dependent claims and the following description of an example of embodiment. In the drawing:

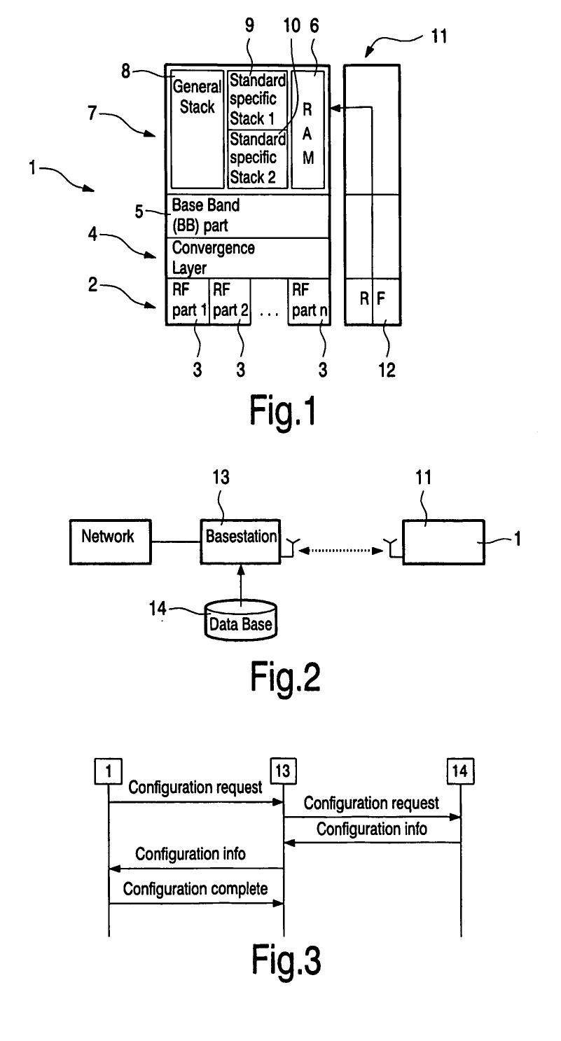

FIG. 1 shows a layer architecture of a mobile terminal for a plurality of cellular communication systems in schematic form,

FIG. 2 gives a diagrammatic representation of the network for the mobile terminal,

FIG. 3 shows a flow chart of the signaling for the configuration of the terminal.

A mobile terminal 1 (compare FIG. 1) has in its lower, analog physical layer 2 two or more RF receive modules 3. Each of the receive modules 3 is arranged as an air interface on one of the communication systems mentioned in the opening paragraph, for example GSM, GPRS, WLAN, in which this terminal is to be able to communicate. The receive modules 3 are exchangeable, for example, as pluggable chips. Preferably only those receive modules 3 are built-in that are arranged for those communication systems in which this terminal is to able to communicate. If the terminal is to be equipped—at a later instant—for a further communication system, a respective further receive module 3 is installed. If the terminal is to be adapted to a further communication system, thus only the respective receive module is to be built-in as hardware. Only the receive modules 3 are to be installed that belong to the communication systems in which the terminal is to be able to communicate.

The receive modules 3 are connected with the usual baseband portion 5 via a hardware convergence layer 4, which baseband portion 5 together with the convergence layer 4 forms a digital physical layer. The convergence layer 4 forms a uniform interface for the connection of the various receive modules 3 with a baseband portion 5.

The terminal 1 has in a higher software layer a protocol stack 7 with an assigned RAM memory 6. The protocol stack 7 is subdivided into a general protocol stack 8 for protocol parts which are used in all communication systems in equal measure and into two reconfigurable specific protocol stacks 9, 10 in which are accommodated the protocol portions which are special in the standard of the respective communication system.

A standard system 11 with an RF receive portion 12 is integrated with the terminal 1. The standard system 11 is used for configuring or loading respectively, a special protocol stack 9, 10 with the specific protocol portions of the communication system with which the terminal 1 can communicate. The standard system 11 may be a stand-alone system or a standard software setting.

In addition to the base stations 13 which support the standard system 11 the network (compare FIG. 2) comprises a central database 14. The database 14 contains the specific protocol portions of the possible communication systems with which terminals can communicate each depending on its receive modules 3. The terminal 1 and the connected base station 3 can be configured with the specific protocol portions during signaling. The specific protocol portions from the database 14 can be loaded via the standard system 11 and the base station 13 in the specific protocol stack 9 or 10 respectively.

Two specific protocol stacks 9, 10 are provided because the reconfiguration lasts a certain period of time. The two specific protocol stacks 9, 10 provide a practically seamless transition from one communication system to the other communication system. For if the terminal 1 works with the first specific protocol stack 9 and wishes to have a connection in another communication system in the area of the other communication system, its specific protocol portion is already loaded in the terminal 1 before a change is made from the one communication system to the other.

The terminal 1 selects, for example, via the standard system 11, in co-operation with the base stations in the area of influence the respective best and/or most reliable communication system given the endemic facts for the desired transmission of, for example, speech, data, images, music.

In cellular communication the standard system is preferably down-link oriented. As high a data rate as possible should be guaranteed from the base station to the terminal to be able to load the specific protocol portions from the database 14 via the base station 13 to the specific protocol stack 9, 10 in a brief period of time.

FIG. 3 shows the signaling for the configuration of the terminal. It begins with a request from the standard system 11 for a new configuration (configuration request), i.e. for the specific protocol portion of a next-suitable communication system. This request is conveyed to the database 14. The necessary information then goes from the database 14 via the base station 13 to the terminal 1 (configuration information). If the configuration is successful, the terminal 1 will send an acknowledgement to the base station 13 (configuration complete).

1. A structure of a mobile terminal for different communication systems which work with different air interfaces and different protocols, characterized in that the terminal (1) in its physical layer contains receive modules (3) for the different air interfaces, in that the terminal (1) has a convergence layer (4) which forms a uniform interface for the coupling of the receive module (3) to higher layers, in that in the higher layers there is a reconfigurable protocol stack (9, 10) with software components for the different protocols, in that the software components are stored in a database (14) remote from the terminal (1) and in that the terminal (1) includes a standard system (11) by which it retrieves the software components of the respective communication system via a base station (13) from the database (14) in its protocol stack (9, 10).

2. A structure as claimed in claim 1, characterized in that the receive modules (3) are exchangeably arranged in the terminal (1).

3. A structure as claimed in claim 1, characterized in that the convergence layer (4) transmits the signals from the receive module (3) to a baseband portion (5) of the terminal (1).

4. A structure as claimed in claim 1, characterized in that the standard system (11) calls the specific protocol portions of the respective suitable communication system from the database (14) according to the place and/or connection request and/or transmission request from the terminal (1) via the base station (13) and loads same in the protocol stack (9, 10) of the terminal (1).

5. A structure as claimed in claim 1, characterized in that the standard system (11) is down-linked oriented.

6. A structure as claimed in claim 1, characterized in that the protocol stack is subdivided into a general protocol stack (8) permanently stored in the terminal (1) and a specific protocol stack (9, 10) for protocol portions corresponding to the respective communication system.

7. A structure as claimed in claim 1, characterized in that two specific protocol stacks (8, 9) are provided in the terminal (1).

8. Mobile terminal for different communication systems which work with different air interfaces and different protocols, characterized in that the terminal (1) in its physical layer contains receive modules (3) for the different air interfaces, in that the terminal (1) has a convergence layer (4) which forms a uniform interface for the coupling of the receive module (3) to higher layers, in that in the higher layers there is a reconfigurable protocol stack (9, 10) with software components for the different protocols, in that the software components are stored in a database (14) remote from the terminal (1) and in that the terminal (1) includes a standard system (11) by which it retrieves the software components of the respective communication system via a base station (13) from the database (14) in its protocol stack (9, 10).

9. Integrated circuit für a mobile terminal which is suitable for different communication systems which work with different air interfaces and different protocols, characterized in that the integrated circuit in its physical layer contains receive modules (3) for the different air interfaces, in that the integrated circuit has a convergence layer (4) which forms a uniform interface for the coupling of the receive module (3) to higher layers, in that in the higher layers there is a reconfigurable protocol stack (9, 10) with software components for the different protocols, in that the software components are stored in a database (14) remote from the integrated circuit and in that the integrated circuit includes a standard system (11) by which it retrieves the software components of the respective communication system via a base station (13) from the database (14) in its protocol stack (9, 10).
